(19) United States
(12) Patent Application Publication
(10) Pub. No.: US 2021/0149788 A1
(43) Pub. Date: May 20, 2021

(54) SOFTWARE DIAGNOSIS USING TRANSPARENT DECOMPILATION

(71) Applicant: Microsoft Technology Licensing, LLC, Redmond, WA (US)

(72) Inventors: Mark Anthony Jelf DOWNIE, Hilliard, OH (US); Jackson DAVIS, Carnation, WA (US); Thomas LAI, Redmond, WA (US); Andrew Richard STERLAND, Issaquah, WA (US); Wai Hang ("Barry") TANG, Redmond, WA (US); Nikolaus KARPINSKY, Edmonds, WA (US)

(21) Appl. No.: 16/687,444

(22) Filed: Nov. 18, 2019

(51) Int. Cl. G06F 11/36; G06F 8/70

(52) U.S. Cl. CPC G06F 11/366; G06F 8/70

(57) ABSTRACT

Embodiments provide improved diagnosis of software defects. Static analysis services and other source-based diagnostic tools and techniques are applied even when the source code underlying software is unavailable. Diagnosis obtains diagnostic artifacts, extracts diagnostic context from the artifacts, decompiles to get source, and submits decompiled source to a source-based software analysis service. The analysis service may be a static analysis tool, an antipattern scanner, or a machine learning model trained on source code, for example. The diagnostic context may also guide the analysis, e.g., by localizing decompilation or prioritizing possible causes. Likely causes are culled from analysis results and identified to a software developer. Changes to mitigate the defect's impact are suggested. Thus, the software developer receives debugging leads without providing source code for the defective program, and without manually navigating through a decompiler and through the analysis services.

### BACKGROUND

A wide variety of computing systems provide functionality that depends at least in part on software. Such computing systems are not limited to laptops or servers or other devices whose primary purpose may be deemed computation. Computing systems also include smartphones, industrial equipment, vehicles (land, air, sea, and space), consumer goods, medical devices, communications infrastructure, security infrastructure, electrical infrastructure, and other systems that execute software. The software may be executed from volatile or non-volatile storage, as firmware or as scripts or as binary code or otherwise. In short, software can be extremely useful in a wide variety of ways.

However, computing systems may have various kinds of functionality defects, which may be due in whole or in part to software defects or deficiencies. Sometimes a computing system follows an erroneous or undesired course of computation, and yields insufficient or incorrect results. Sometimes a computing system hangs, by stopping entirely, or deadlocking, or falling into an infinite loop. Sometimes a computing system provides complete and correct results, but is slow or inefficient in its use of processor cycles, memory space, network bandwidth, or other computational resources. Sometimes a computing system operates efficiently and provides correct and complete results, but does so only until it succumbs to a security vulnerability.

Accordingly, advances and improvements in the functionality of computing systems may be obtained by advancing or improving the tools and techniques available for identifying and understanding functionality defects of software. This includes in particular defects in any software that is used to create, deploy, operate, update, manage, or diagnose computing system software.

### SUMMARY

Some embodiments described in this document provide improved diagnosis of defects in computing systems. In particular, some embodiments allow a software developer to bring static analysis services and other source-based diagnostic tools and techniques to bear on defective software even when the relevant source code of that software is unavailable to the developer. In this regard, a “developer” is any person who is tasked with, or attempting to, create, modify, deploy, operate, update, manage, or understand functionality of software.

Some embodiments help identify causes of computing functionality defects by automatically obtaining a diagnostic artifact associated with a computing functionality defect of a program, extracting a diagnostic context from the diagnostic artifact, getting a decompiled source which corresponds to at least a portion of the program, and submitting at least a portion of the decompiled source to a source-based software analysis service. The diagnostic context or conclusions based on it may also be used to guide the analysis. In response to the submitting, some embodiments receive from the source-based software analysis service or from another analysis service (or from both) an analysis result which indicates a suspected cause of the computing functionality defect. Based on this, the embodiment identifies the suspected cause to a software developer. Some also suggest changes that can mitigate the defect's impact. Whether mitigations are suggested or not, some embodiments automatically provide the software developer with a debugging lead without requiring the software developer to provide source code for the program that is being debugged, and without requiring the developer to manually navigate through a decompiler and the analysis service(s).

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating situations in which a program's execution and the program's source are on opposite sides of a trust boundary;

FIG. 3 is a block diagram illustrating some aspects of software defect diagnosis in some situations and some environments;

FIG. 4 is a block diagram illustrating some embodiments of a defect diagnosis system;

FIG. 5 is a block diagram illustrating some examples of source-based software analysis services;

FIG. 6 is a block diagram illustrating some examples of root causes of software defects;

FIG. 7 is a data flow diagram illustrating several kinds of data and several tools or other services which may generate or process the data during diagnosis of a defect;

FIG. 8 is a flowchart illustrating steps in some software defect diagnosis methods; and

FIG. 9 is a flowchart further illustrating steps in some software defect diagnosis methods.

### DETAILED DESCRIPTION

Overview

Innovations may expand beyond their origins, but understanding an innovation's origins can help one more fully appreciate the innovation. In the present case, some teachings described herein were motivated by technical challenges faced by Microsoft innovators who were working to improve the usability and coverage scope of Microsoft software development offerings.

In particular, a technical challenge was to how to make debugging and diagnosing complex issues easier and faster, and how to allow more developers to tackle complex production issues. Innovations that successfully address such challenges will ultimately improve developer productivity and satisfaction for development tool offerings, including not only Microsoft Visual Studio® offerings and its associate platforms, but also enhanced development tools from other vendors who are authorized to use the innovations claimed here (mark of Microsoft Corporation). Better software development offerings lead directly to improvements in the functioning of computing systems themselves, as the software running those systems improves.

As a particular example, consider an async-sync defect, which may occur when a program implements a sync-over-async pattern. This pattern allows a component X to synchronously invoke a component Y, even though Y has an asynchronous implementation. A runtime may intercept this synchronous invocation by X and switch it to an asynchronous implementation, leading to thread pool depletion, debilitating exceptions, and other unexpected and unwanted behavior. Faced with such situations, some familiar approaches tend to only reveal where a second chance exception occurred, or where the program finally hung. In the case of an async-void hang a familiar approach might at best land a debugger in some decompiled code of a runtime or other framework, giving the developer no clear mechanism for finding the location in application source code where the real issue originated.

When debugging an application, developers sometimes study the application's source code. Such study might reveal, to some developers, the sync-over-async pattern or other antipatterns. But in many cases, developers are called on to understand and even debug through the executable code of an application program for which they do not have any source code. Locating the source code which was used to create the application may be time-consuming and difficult, or that original source may be inaccessible as a practical matter due to an intervening trust boundary. As used herein, the “original source” of an executable includes any source code which was compiled to create the executable, not necessarily the initial version of such source code.

Decompiling an application—rather than decompiling a runtime or a framework—may be a step in a good direction. But simply presenting decompiled application code in the debugger may not be enough to help developers who did not write that code actually understand how that code behaves (or misbehaves). In particular, unless symbols are available, decompiled code is difficult to understand because much of the meaning expressed in identifier names in the original source may be missing from the decompiled source. Symbols, like original source, may be difficult to locate or may be beyond reach.

Some embodiments presented here provide developers with a better understanding of the root cause of a program failure, even when the program's source code is not accessible, and even when the developer is not personally familiar with the antipattern responsible for the failure. This is accomplished in some embodiments by automatically decompiling a relevant portion of the program and feeding the decompiled source into an expert tool or a machine learning module which analyzes the decompiled source and suggests possible causes for the failure. Unlike human developers, source-based software analysis tools are not hampered by the lack of human-meaningful identifiers in decompiled source.

Embodiments may also check for antipatterns that the particular developer in question is unfamiliar with, or might otherwise overlook.

Moreover, unlike a purely static analysis, the analysis performed by some embodiments uses dynamic information to guide 946 a source-based static analysis. For example, a dump of thread information may indicate that the thread pool is empty, causing the source-based analyzer to check the decompiled source for a sync-over-async pattern. As another example, call stack information or other dynamic information can be used to guide decompilation, so that computational resources are not wasted decompiling portions of the program that have little or no relevance to the program's failure, and likewise computational resources are not wasted performing static analysis on irrelevant portions of the program.

These are merely examples. Other aspects of these embodiments and other software defect diagnosis embodiments are also described herein.

Operating Environments

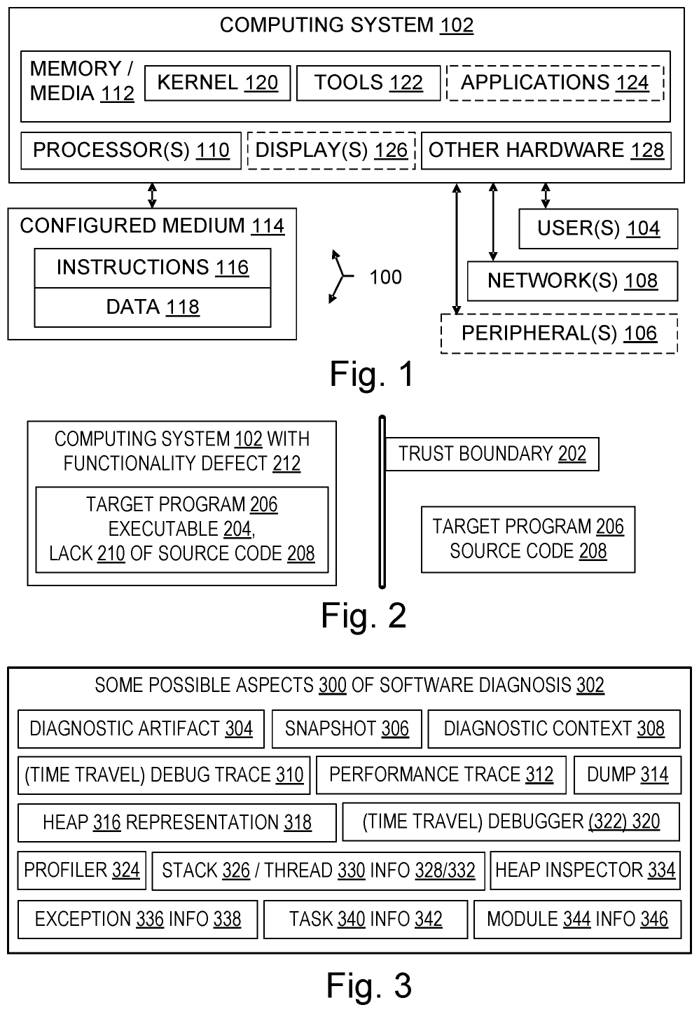

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Storage media 112 may be of different physical types. The storage media 112 may be volatile memory, non-volatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage medium 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software defined network or a sandboxed or other secure cloud computing environment. In some embodiments, one or more computers are partially or fully “air gapped” by reason of being disconnected or only intermittently connected to another networked device or remote cloud. In particular, defect diagnosis functionality could be installed on an air gapped system and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More about Systems

FIG. 2 illustrates situations in which a trust boundary 202 separates an executable 204 of a program 206 from a source code 208 that is a basis for that executable 204. Thus, on the executable's side of the trust boundary, there is a lack 210 of the source code 208 from which the executable 204 originated. The original source code 208 could be helpful in diagnosing a functionality defect 212 exhibited by the system 102 in which the executable 204 executes, but crossing the trust boundary 202 to get at the original source code is difficult, unduly time-consuming, too expensive, or otherwise not feasible for a developer who wants to diagnose the underlying cause(s) of the defect 212. For example, due to the intervening trust boundary 202, accessing the source code 208 may require authentication or authorization credentials that the developer does not have and cannot readily obtain.

FIG. 3 illustrates various aspects 300 of software defect diagnosis 302. These aspects are discussed at various points herein, and additional details regarding them are provided in the discussion of a List of Reference Numerals later in this disclosure document.

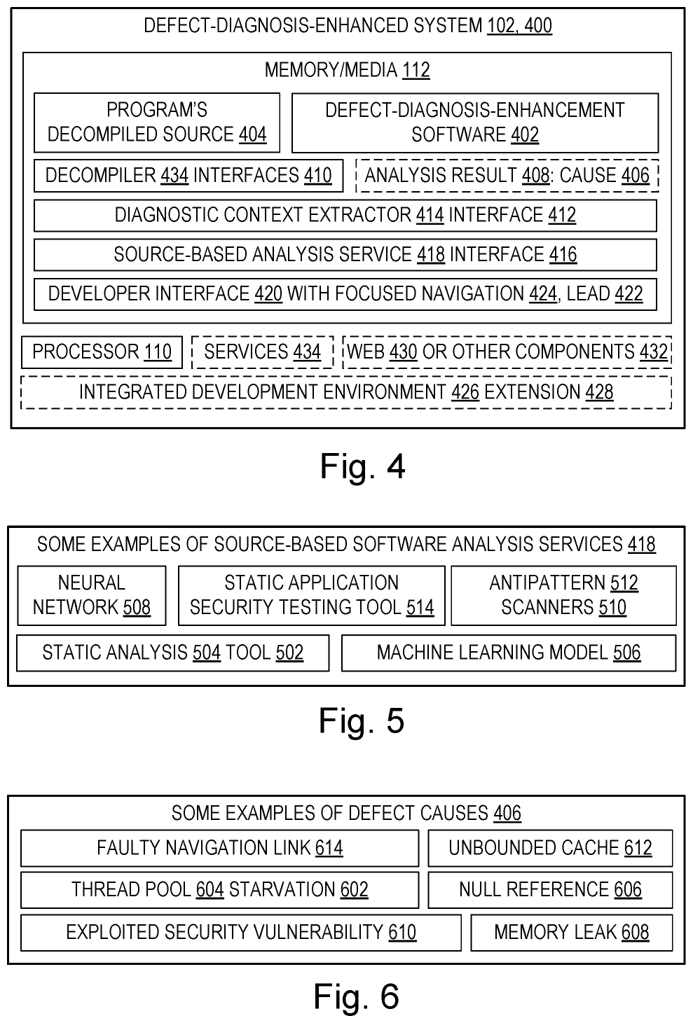

FIG. 4 illustrates some embodiments of a defect diagnosis system 400, which is a system 102 having some or all of the diagnosis functionality enhancements taught herein. The illustrated system 400 includes defect-diagnosis-enhancement software 402. Software 402 detects or receives an indication 802 that a defect 212 is to be diagnosed. In response, software 402 automatically obtains relevant diagnostic artifacts 304, extracts diagnostic context 308 from the artifacts 304, gets decompiled source 404, analyzes the decompiled source 404 in view of the diagnostic context 308, and identifies to a developer one or more suspected underlying causes 406 of the defect 212, which are culled from the analysis results 408. The defect 212 may be manifest in any kind of target program 206, and in particular may manifest itself (or be hidden in) in a web component 430 or another component 432 of a target program 206.

In some embodiments, instructions 116 to perform some or all of these operations is embedded in diagnosis software 402. However, an embodiment may also perform diagnosis 302 by invoking separate tools or other services that also exist and function independently of and outside of the diagnosis software 402. Accordingly, the example illustrated in FIG. 4 includes decompiler interfaces 410, interfaces 412 to one or more diagnostic context extractors 414, and interfaces 416 to one or more source-based analysis services 418.

Regardless of the mix of embedded operations versus external invoked operations, a developer interface 420 eventually displays the suspected causes 406 to a developer as part or all of a diagnostic lead 422. In addition to identifying causes 406, a diagnostic lead may include suggestions for reducing or removing the unwanted impact of the defect 212. A lead 422 may also display some of the decompiled source 404 to help the developer better understand the defect 212.

In some embodiments, the developer interface 420 offers the developer only tightly focused navigation 424. For example, the navigation 424 available to the developer in the developer interface 420 may avoid displaying the interfaces or interface data of a decompiler 434, an artifact collector 704, or a diagnostic context extractor 414. Thus, an embodiment may provide the software developer with a debugging lead without requiring the software developer to navigate through the diagnostic context 308, and without requiring the software developer to be familiar with the interfaces of tools or services that perform artifact collection, diagnostic context extraction, decompilation, or source-based software analysis.

In some embodiments, diagnosis software 402 is embedded in an Integrated Development Environment (IDE) 426, or is accessible through an IDE, e.g., by virtue of an IDE extension 428. An IDE 426 generally provides a developer with a set of coordinated computing technology development tools 122 such as compilers, interpreters, decompilers, assemblers, disassemblers, source code editors, profilers, debuggers, simulators, fuzzers, repository access tools, version control tools, optimizers, collaboration tools, and so on. In particular, some of the suitable operating environments for some software development embodiments include or help create a Microsoft® Visual Studio® development environment (marks of Microsoft Corporation) configured to support program development. Some suitable operating environments include Java® environments (mark of Oracle America, Inc.), and some include environments which utilize languages such as C++ or C# (“C-Sharp”), but many teachings herein are applicable with a wide variety of programming languages, programming models, and programs.

FIG. 5 illustrates some examples of source-based analysis services 418. The examples shown include tools 502 that perform static analysis 504, machine learning models 506 trained on source code, source-code trained neural networks 508, scanners 510 that look for antipatterns 512, and static application security testing (SAST) tools 514. This set of examples is not exhaustive. Also, these examples are not necessarily mutually exclusive. For instance, a neural network 508 is one kind of machine learning model 506. Similarly, a SAST tool 514 may include a scanner 510 for security vulnerability antipatterns 512.

FIG. 6 illustrates some examples of defect causes 406. The examples shown include thread pool starvation 602, a null reference 606, a memory leak 608, an exploited security vulnerability 610, an unbounded cache 612, and a faulty navigation link 614. This set of examples is not exhaustive. Also, these examples are not necessarily mutually exclusive. For instance, a failure to validate input may be exploited as a security vulnerability 610 which overwrites part of an executable 204 and thus creates a null reference 606 or a faulty navigation link 614.

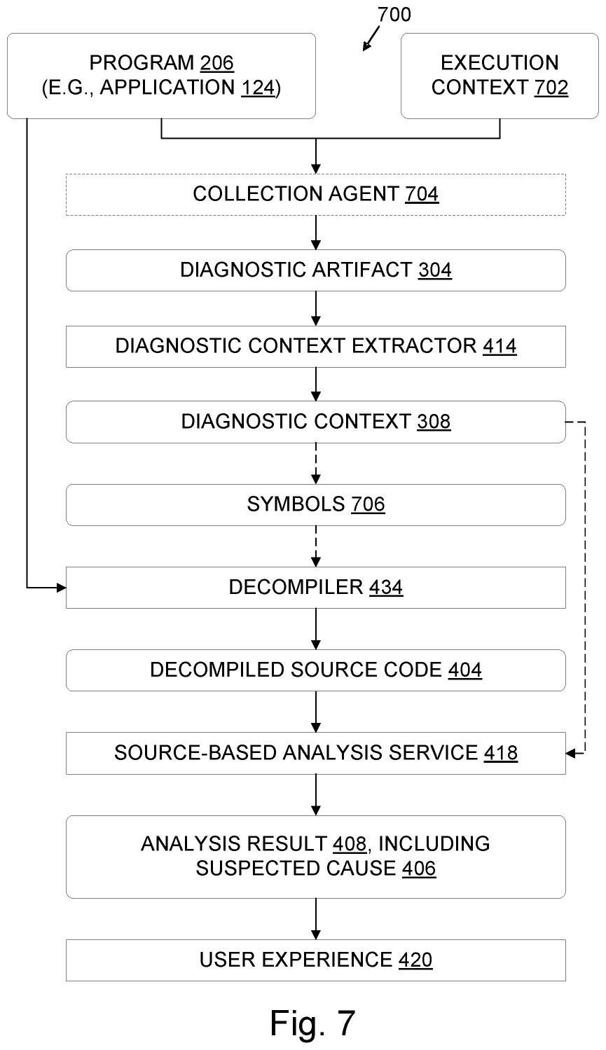

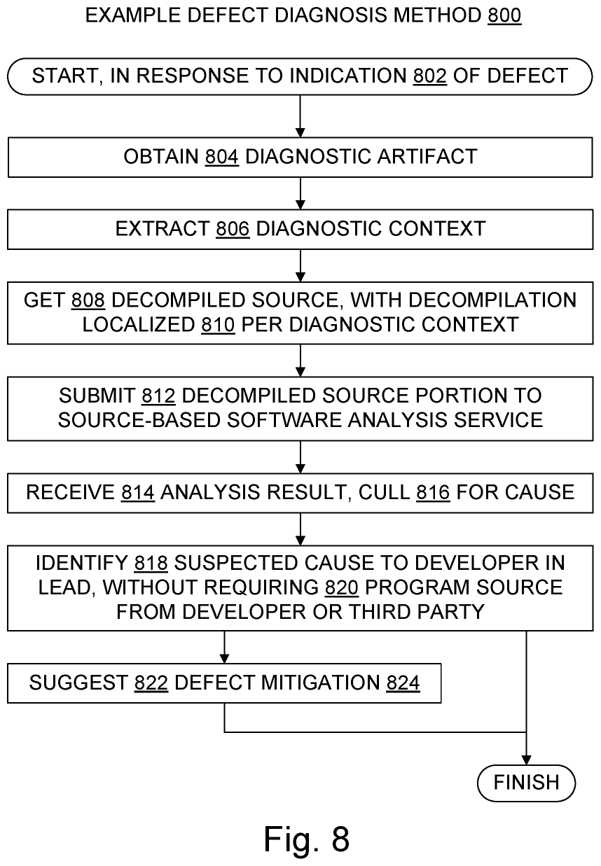

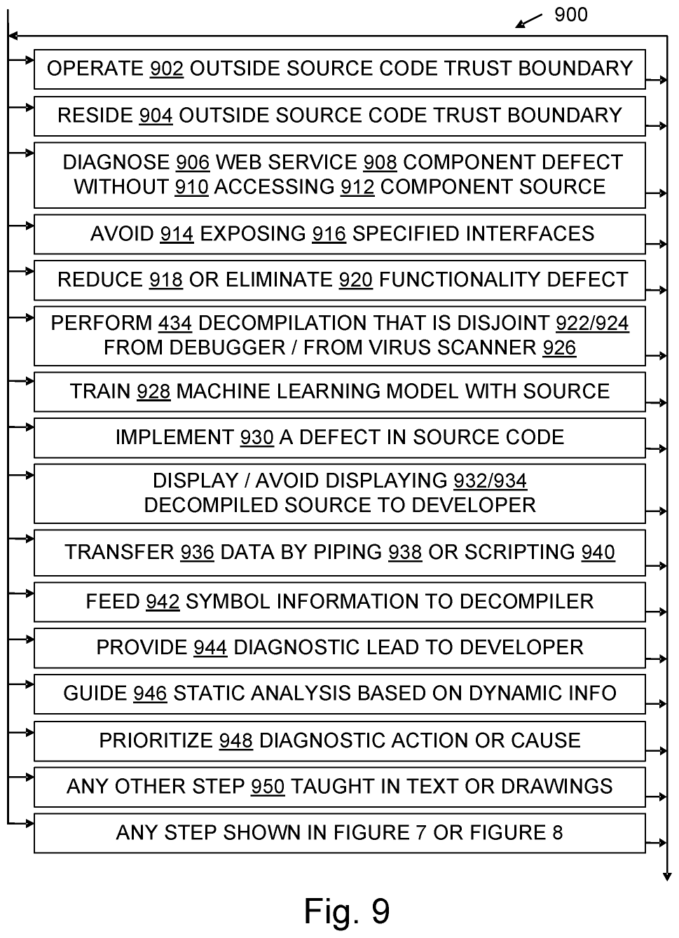

FIGS. 7-9 illustrate several kinds of data 118 and several tools 122 or other services 436 which may generate or process the data during diagnosis 302 of a defect 212. A target program is executing (or previously executed, or both) in an execution context 702. At some point, an indication 802 of a defect 212 is detected. In response, a defect diagnosis method starts, such as the method shown in FIG. 8 or a method according to the data flow shown in FIG. 7. One or more collection agents 704 may then automatically collect diagnostic artifacts 304 associated with the target program 206. As indicated by dashed lines in FIG. 7, use of a collection agent is optional in some embodiments. For instance, some or all of the steps shown in FIG. 7 or FIG. 8 or both could be integrated directly into a live debugger 320 or a time travel debugger 322.

After diagnostic artifacts 304 are collected by an agent 704, or otherwise obtained 804, or concurrently therewith, diagnostic context 308 is automatically extracted 806 from the artifacts. Extraction may be performed, e.g., by one or more diagnostic context extractors 414. In particular, some embodiments in some situations automatically extract 806 a symbol table 706 or other symbol data 706 from an executable, or from a debug info file.

In the illustrated embodiments, some or all of the program executable 204 is automatically fed to a decompiler 434, thus allowing the embodiment to get 808 decompiled source 404. When symbols 706 are available, they may also be automatically fed 942 to the decompiler 434, which may then use the symbols to produce decompiled source 404 that is closer in content to the original source 208 than would otherwise be produced by decompilation. In particular, managed code metadata may include symbols 706 which give the names of classes and methods. When symbols 706 are not available, human-meaningful defaults may be used, e.g., local variables in a routine may be named “local1”, “local2”, and so on.

In FIG. 7 the inputs to the decompiler 434 are shown by a solid line and a dashed line. The dashed line shows symbols 706 from a diagnostic context, because in the illustrated embodiments the decompiler may use symbols but does not require them. The solid line is from the Program 206 because in the illustrated embodiments the decompiler always uses the program's executable (typically binary) to produce source code 404.

Decompilation 434 is considered here a technical action. Like other technical actions, when decompilation is done in particular circumstances it may also have a legal context, e.g., decompilation may implicate a license agreement, or it may implicate one or more statutes or doctrines of copyright law, or both. Such considerations are beyond the scope of the present technical disclosure. The present disclosure is not meant to be a grant or denial of permission under an end user license agreement, for example, and is not presented as a statement of policy or law regarding non-technical non-patent aspects of decompilation.

In some embodiments, decompilation 434 is automatically localized 810 in view of the diagnostic context. For example, instead of decompiling an entire executable 204, portions of the executable may be iteratively decompiled and analyzed 812. If the diagnostic context 308 includes a stack return address, for instance, then executable code at that location may be decompiled first, or at least have higher priority 948 for decompilation. If the diagnostic context includes a hard-coded file name or URL as part of a file or URL access attempt which apparently failed, then executable code 204 may be scanned for the file name or URL, and portions of the executable surrounding instances of the file name or URL may receive higher priority for decompilation. If the diagnostic context 308 includes a list of active thread IDs and an indication that a defect 212 involving threads may have occurred, then portions of the executable surrounding instances of those thread IDs, or executable portions surrounding identifiable thread operations such as thread creation or interthread messaging, may receive higher priority for decompilation. More generally, information in the diagnostic context 308 may be used to automatically guide 946 diagnostic decompilation toward particular portions of an executable.

In the illustrated embodiments, some or all of the decompiled source 404 is automatically submitted 812 to one or more source-based software analysis services 418. The same source 404 may be submitted to different analysis services 418, or different parts of the source 404 may be submitted to different analysis services 418. If some original source 208 is available, it may also be submitted 812 for analysis. That is, depending on the circumstances, the decompiled source 404 may be used as a replacement for unavailable original source 208, as a supplement to fill gaps in the available original source 208, or as a replacement for some of the original source and a supplement to fill in gaps between pieces of original source.

In FIG. 7, the inputs to the source-based analysis service 418 are shown by a solid line and a dashed line. The solid line is from decompiled source code 404, because in the illustrated embodiments the source-based analysis service always requires some decompiled source code. The dashed line is from the diagnostic context 308 because in the illustrated embodiments the source-based analysis service may use the diagnostic context but does not always require the diagnostic context.

In the illustrated embodiments, the diagnosis software 402 automatically receives 814 analysis results 408 from one or more analysis services 418. Suspected causes 406 may be automatically culled 816 from the results, e.g., by discarding error messages and error codes, discarding text or status codes that indicate no cause was found by the analysis, and filtering out other extraneous material that was output by the service(s) 418. Then suspected causes 406 are displayed or otherwise automatically identified 818 to a software developer 104.

In the illustrated embodiments, the identification 818 may sometimes be performed directly by an output interface 416 of an analysis service 418. But the other tool interfaces (decompiler interfaces 410, diagnostic context extractor interfaces 412, analysis service input interface 416) and their corresponding data transfers may be hidden from the developer, e.g., by being excluded 914 from the available navigation 424 options. Likewise, although some original source 208 may be used by some embodiments if it is available, in general the suspected causes 406 are automatically identified 818 to the developer without requiring 820 the developer to supply original source 208 to the analysis service(s) 418.

Some embodiments suggest 822 defect mitigations 824 to the developer. Mitigations 824 may be suggested by displaying them, or displaying links to them, or displaying summaries of them, along with the suspect cause identification 818. For example, a mitigation 824 for a buffer overflow 406 may display to the developer an example of validation code which can be added (e.g., as a patch or a preprocessor) to the program 206 to check the size of data before the data is written to a buffer. A mitigation 824 for a cause 406 that is not readily patched away or avoided by preprocessing may suggest that the developer use an alternate library which provides similar functionality but has no reported instances of the cause 406 occurring. More generally, particular mitigations 824 will relate to particular causes 406 or sets of causes 406.

Some embodiments use or provide a diagnosis functionality-enhanced system, such as system 400 or another system 102 that is enhanced as taught herein for identifying causes of computing functionality defects. The diagnostic system includes a memory 112, and a processor 110 in operable communication with the memory. The processor 110 is configured to perform computing functionality defect 212 identification steps which include (a) obtaining 804 a diagnostic artifact 304 associated with a computing functionality defect 212 of a program 206, (b) extracting 806 a diagnostic context 308 from the diagnostic artifact, (c) transparently decompiling 434 at least a portion of the program, thereby getting 808 a decompiled source 404 which corresponds to the portion of the program, (d) submitting 812 at least a portion of the decompiled source and at least a portion of the diagnostic context 308 to a source-based software analysis service 418, (e) receiving 814 from the source-based software analysis service an analysis result 408 which indicates a suspected cause 406 of the computing functionality defect, and (f) identifying 818 the suspected cause to a software developer. Thus, the enhanced system 400 provides the software developer with a debugging lead 422 without requiring the software developer to navigate through the diagnostic context. As used here, “transparently decompiling” means decompiling 434 without receiving a decompile command per se from the developer and without displaying any decompiler interfaces 410 (intake interface, output interface) to the developer.

In some embodiments, the system 400 resides 904 and operates 902 on one side of a trust boundary 202, and no source code 208 of the program 206 other than decompiled source 404 resides on the same side of the trust boundary as the diagnostic system.

In some embodiments, the memory 112 contains and is configured by the diagnostic artifact 304, and the diagnostic artifact includes at least one of the following: an execution snapshot 306, an execution dump 314, a time travel debugging trace 310, a performance trace 312, or a heap representation 318.

In some embodiments, the memory 112 contains and is configured by the analysis result 408, and the analysis result indicates at least one of the following is a suspected cause 406 of the computing functionality defect 212: a thread pool starvation 602, a null reference 606, an unbounded cache 612, or a memory leak 608.

In some embodiments, the system 400 includes at least one of the following diagnostic context extractors: a debugger 320, a time travel trace debugger 322, a performance profiler 324, or a heap inspector 334.

In some embodiments, the memory 112 contains and is configured by the diagnostic context 308, and the diagnostic context includes at least one of the following: call stacks 326, exception information 338, module state information 346, thread state information 332, or task state information 342.

In some embodiments, the system includes the source-based software analysis service 418, and the source-based software analysis service includes or accesses at least one of the following: a static analysis tool 502, or a machine learning model 506.

Other system embodiments are also described herein, either directly or derivable as system versions of described processes or configured media, informed by the extensive discussion herein of computing hardware.

Although specific architectural examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different technical features, mechanisms, sequences, data structures, or functionalities for instance, and may otherwise depart from the examples provided herein.

Processes (a.k.a. Methods)

FIGS. 7 and 8 illustrates families of methods 700, 800 that may be performed or assisted by an enhanced system, such as system 400, or another defect diagnosis functionality-enhanced system as taught herein. FIG. 9 further illustrates defect diagnosis methods (which may also be referred to as “processes” in the legal sense of that word) that are suitable for use during operation of a system which has innovative functionality taught herein. FIG. 9 includes some refinements, supplements, or contextual actions for steps shown in FIG. 7 or FIG. 8 or both. FIG. 9 also incorporates steps shown in FIG. 7 or FIG. 8 or both. Technical processes shown in the Figures or otherwise disclosed will be performed automatically, e.g., by software 402 as part of a development toolchain, unless otherwise indicated. Processes may also be performed in part automatically and in part manually to the extent action by a human administrator or other human person is implicated, e.g., in some embodiments a software developer may specify where software 402 should search for a dump 314 or a trace 310 or 312 to start the diagnostic method. No process contemplated as innovative herein is entirely manual. In a given embodiment zero or more illustrated steps of a process may be repeated, perhaps with different parameters or data to operate on. Steps in an embodiment may also be done in a different order than the top-to-bottom order that is laid out in FIGS. 7-9. Steps may be performed serially, in a partially overlapping manner, or fully in parallel. In particular, the order in which data flow chart 700 action items, control flowchart 800 action items, or control flowchart 900 action items are traversed to indicate the steps performed during a process may vary from one performance of the process to another performance of the process. The chart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments use or provide a method for identifying causes of computing functionality defects, including the following steps performed automatically: obtaining 804 a diagnostic artifact associated with a computing functionality defect of a program, extracting 806 a diagnostic context from the diagnostic artifact, getting 808 a decompiled source which corresponds to at least a portion of the program, submitting 812 at least a portion of the decompiled source to a source-based software analysis service, receiving 814 (in response to the submitting) from the source-based software analysis service an analysis result which indicates a suspected cause of the computing functionality defect, and identifying 818 the suspected cause to a software developer. This method automatically provides 944 the software developer with a debugging lead without requiring 820 the software developer to provide source code (decompiled or original) for the program.

With some embodiments, the developer 104 does not need to directly operate the diagnostic context extractor 414, or the decompiler 434, or the software analysis service 418. Instead, the diagnostic context extractor interfaces are hidden from the developer, and all of the decompiler interfaces are hidden from the developer. In this example, only the input interface of the software analysis service is hidden. This allows the software analysis service to report directly to the developer, in addition to situations where the software analysis service reports to other software 402, 420 that reports 818 in turn to the developer. Specifically, in some embodiments the method avoids 914 exposing 916 any of the following to the software developer during an assistance period which begins with the obtaining 804 and ends with the identifying 818: any diagnostic context extractor user interface 412, any decompiler user interface 410, and any intake interface 416 of the source-based software analysis service.

In some embodiments, the software analysis service 418 or another function of the diagnostic software 402 may provide a fix or make another suggestion that can be given to the developer. Specifically, in some embodiments, the method further includes suggesting 822 to the software developer a mitigation 824 for reducing or eliminating the computing functionality defect.

Teachings herein may be applied in a wide variety of software environments. In particular, web-facing software in production environments can be very difficult to diagnose, so it may happen that teachings herein provide particularly welcome benefits by finding possible root causes for a bug in a web service third-party library without requiring access to the source code for that library. Thus, with some embodiments, the program 206 includes an executable component 432 which upon execution supports a web service 908, the computing functionality defect 212 is associated with the executable component, the executable component is a compilation result of a component source 208, and the method is performed 944 without 910 accessing the component source.

In some embodiments, submitting 812 includes submitting at least a portion of the decompiled source 404 to at least one of the following analysis services 418: a machine learning model 506 trained using source codes, or a neural network 508 trained using source codes.

In some, a source-based software analysis service 418 includes a machine learning model that was trained using source code examples of a particular defect 212, e.g., source code examples of a null reference exception 336. Thus, submitting 812 may include submitting at least a portion of the decompiled source to a machine learning model trained 928 using multiple source code implementations of the computing functionality defect, and the decompiled source may also implement 930 the computing functionality defect, allowing detection of that defect by the trained model.

In some embodiments, decompiling 434 is disjoint 922 from any debugger 320, 322. In some, decompiling 434 is disjoint 924 from any virus scanner 926. In some, decompiling 434 is disjoint 922, 924 from debuggers and from virus scanners. An operation X is “disjoint” from a tool Y when X is not launched by Y and when execution of Y is not reliant upon performance of X.

In some embodiments, the method includes transferring 936 at least a portion of the diagnostic context from a diagnostic context extractor to a decompiler. In some, it includes transferring 936 at least a portion of the decompiled source from the decompiler to the source-based software analysis service. Some methods include both transfers. In any of these, the transferring 936 may be performed using piping 938, or scripting 940, or both.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as defect diagnosis software 402, decompilers 434, diagnostic context extractors 414, source-based analysis services 418, and developer interfaces 420, in the form of data 118 and instructions 116, read from a removable storage medium 114 and/or another source such as a network connection, to form a configured storage medium. The configured storage medium 112 is capable of causing a computer system 102 to perform technical process steps for software defect diagnosis, as disclosed herein. The Figures thus help illustrate configured storage media embodiments and process (a.k.a. method) embodiments, as well as system and process embodiments. In particular, any of the process steps illustrated in FIGS. 7-9, or otherwise taught herein, may be used to help configure a storage medium to form a configured storage medium embodiment.

Some embodiments use or provide a computer-readable storage medium 112, 114 configured with data 118 and instructions 116 which upon execution by at least one processor 110 cause a computing system to perform a method for identifying causes of computing functionality defects in a program. This method includes: transparently getting 808 a decompiled source which corresponds to at least a portion of the program; submitting 812 at least a portion of the decompiled source to a source-based software analysis service, together with at least a portion of the diagnostic context or a conclusion based on the diagnostic context; in response to the submitting, receiving 814 from the source-based software analysis service or from another analysis service or from both at least one analysis result which indicates a suspected cause of a computing functionality defect in the program; and identifying 818 the suspected cause to a software developer; thereby automatically providing 944 the software developer with a debugging lead without requiring 820 the software developer to provide source code for the program, and without requiring 914 the software developer to navigate through a diagnostic context of the program.

In some embodiments, transparently getting 808 a decompiled source includes transparently feeding 942 a decompiler some symbol information 706 of the program. Here as elsewhere in this document, “transparently” means taking action in a way that is transparent to (unseen by) the developer, although the effects of transparent actions may be visible to the developer.

In some embodiments, the method includes submitting 812 at least a portion of the decompiled source to each of a plurality of source-based software analysis services, receiving 814 a respective analysis result from each of at least two source-based software analysis services, and identifying 818 multiple suspected causes to the software developer.

In some embodiments, identifying 818 the suspected cause to the software developer includes displaying 932 decompiled source to the software developer. But in some other embodiments, the method avoids 934 displaying decompiled source to the software developer.

Some Additional Scenarios

In one diagnostic scenario, the method starts after a program 206 times out. The method is implemented in an enhanced debugger that gathers artifacts 304, decompiles program executable, and submits the decompiled source to static analysis tools and machine learning models. The analysis services report that the program timed out waiting for a thread from an empty thread pool. This is a helpful lead. It may be particularly appreciated because thread pool starvation circumstances may be so extreme that they occur only in production when the program is heavily exercised in unexpected ways.

In another scenario, the analysis identifies an unbounded cache 612 as a possible cause 406. Because the diagnosis software 402 performs decompiling with the benefit of a current diagnostic context 308, the diagnosis software 402 can utilize additional information such as the size of the cache or the lifetime of objects, which traditional static analyzers bereft of such context do not utilize.

Another scenario involves synch over async as a root cause. This cause results in thread pool starvation, as the system running program 206 is blocking threads that are supposed to be handling user requests for the duration of an async task. Static analysis of the source code combined with analysis of the task state and thread state will identify this bug and suggest an appropriate fix, e.g., monitoring synchronous calls, or intentionally making them asynchronous.

Some scenarios involve finding known buggy code which has been mined out of other code bases. Suitably trained machine learning models can spot such code, even if some modifications have been made to the source that make it different than the training source code.

Some scenarios involve memory leak cause analysis. When the tool 402 sees large counts of dominating objects and increasing memory performance counters, it can search the decompiled source code to find common antipatterns such as unbounded caches, responsive to information derived from the allocation stacks and source code analysis.

Some diagnostic scenarios involve automatically detecting common antipatterns when examining diagnostic artifacts such as dumps or performance traces. Given a diagnostics artifact (crash dump, performance trace, time travel debugging trace, snapshot, etc.) derived from, for example, an async-void hang or a null reference crash, an embodiment provides features and abilities to perform operations such as the following: determine the correct call stack from which the issue derived, use the call stack to record a specific Time Travel Debugging trace to the origins of the issue, run a series of bots 418 over all the diagnostics artifacts to generate suggested explicit fixes to the source code. Once a root cause is identified, an embodiment may would also analyze the code for other as yet undetected, but related issues and antipatterns.

In some scenarios, an embodiment allows developers with less technical expertise than was previously required to analyze issues in production and resolve them. Unlike some other approaches, with some embodiments according to teachings herein a developer is not required to interpret raw data of diagnostics artifacts in order to reason about the root cause. Instead, an embodiment may show the developer the root cause based on automated analysis. In particular, use of automatic integrated decompilation as taught herein makes additional analysis techniques possible.

In some scenarios, an embodiment provides an enhanced diagnostic experience, in that diagnostic tools don't merely show symptoms to the investigating developer, but instead identify a root cause and give suggestions for a fix. This experience may be driven by expert systems, and machine learning based algorithms that consume source code, changing developers' experience of code analysis and bug reports. By decompiling the machine code of the application, an embodiment enables the use of expert systems or machine learning tools that use source code as their primary input. This capability, combined with dynamic diagnostic data such as call stacks, thread lists, task lists, and the like, allow the enhanced system to show the developer the root cause based on all of the evidence in the run, including static and dynamic analysis of the source code even when original source code is not available to the developer.

Additional Details, Examples, and Observations

Additional support for the discussion above is provided below. For convenience, this additional support material appears under various headings. Nonetheless, it is all intended to be understood as an integrated and integral part of the present disclosure's discussion of the contemplated embodiments.

Technical Character

The technical character of embodiments described herein will be apparent to one of ordinary skill in the art, and will also be apparent in several ways to a wide range of attentive readers. Some embodiments address technical activities such as software defect diagnosis, decompilation, extraction of internal software context, and automated analysis based on program source code, which are each activities deeply rooted in computing technology. Some of the technical mechanisms discussed include, e.g., decompilers, pipes, scripts, heaps, stacks, threads, and exceptions. Some of the technical effects discussed include, e.g., antipattern detection, machine learning training, provision of software defect diagnostic leads, avoidance of reliance on original source code, localization of decompilation, and focused navigation which hides specified interfaces. Thus, purely mental processes are clearly excluded. Other advantages based on the technical characteristics of the teachings will also be apparent to one of skill from the description provided.

Some embodiments described herein may be viewed by some people in a broader context. For instance, concepts such as analysis, clues, context, corrections, deficiencies, and learning may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to automatically provide useful diagnostic leads to help developers understand and improve software functionality. Other configured storage media, systems, and processes involving analysis, clues, context, corrections, deficiencies, or learning are outside the present scope. Accordingly, vagueness, mere abstractness, lack of technical character, and accompanying proof problems are also avoided under a proper understanding of the present disclosure.

Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples, machine learning models, programming languages, software processes, development tools, identifiers, data structures, data organizations, notations, control flows, pseudocode, naming conventions, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GPU: graphical processing unit

GUI: graphical user interface

HTTP: hypertext transfer protocol; unless otherwise stated, HTTP includes HTTPS herein

HTTPS: hypertext transfer protocol secure

IaaS or IAAS: infrastructure-as-a-service

ID: identification or identity

IDE: integrated development environment

IoT: Internet of Things

LAN: local area network

LDAP: lightweight directory access protocol

OS: operating system

PaaS or PAAS: platform-as-a-service

RAM: random access memory

ROM: read only memory

SAST: static application security testing

SIEM: security information and event management; also refers to tools which provide security information and event management

SQL: structured query language

TPU: tensor processing unit

UEFI: Unified Extensible Firmware Interface

URI: uniform resource identifier

URL: uniform resource locator

VM: virtual machine

WAN: wide area network

XSS: cross-site scripting

XXE: XML eXternal Entity Injection

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write).

“IoT” or “Internet of Things” means any networked collection of addressable embedded computing nodes. Such nodes are examples of computer systems as defined herein, but they also have at least two of the following characteristics: (a) no local human-readable display; (b) no local keyboard; (c) the primary source of input is sensors that track sources of non-linguistic data; (d) no local rotational disk storage—RAM chips or ROM chips provide the only local memory; (e) no CD or DVD drive; (f) embedment in a household appliance or household fixture; (g) embedment in an implanted or wearable medical device; (h) embedment in a vehicle; (i) embedment in a process automation control system; or (j) a design focused on one of the following: environmental monitoring, civic infrastructure monitoring, industrial equipment monitoring, energy usage monitoring, human or animal health monitoring, physical security, or physical transportation system monitoring. IoT storage may be a target of unauthorized access, either via a cloud, via another network, or via direct local access attempts.

“Access” to a computational resource includes use of a permission or other capability to read, modify, write, execute, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Defect diagnosis operations such as decompilation, static analysis, antipattern scanning, piping, script execution, and many other operations discussed herein, are understood to be inherently digital. A human mind cannot interface directly with a CPU or other processor, or with RAM or other digital storage, to read and write the necessary data to perform the software diagnosis steps taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general purpose processor which executes it, thereby transforming it from a general purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as accessing, analyzing, collecting, decompiling, diagnosing, displaying, eliminating, extracting, feeding, getting, identifying, implementing, localizing, obtaining, operating, performing, providing, receiving, reducing, residing, submitting, suggesting, training, transferring (and accesses, accessed, analyzes, analyzed, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment
102 computer system, also referred to as computational system or computing system
104 users, e.g., software developers
106 peripherals
108 network generally, including, e.g., LANs, WANs, software defined networks, clouds, and other wired or wireless networks
110 processor
112 computer-readable storage medium, e.g., RAM, hard disks
114 removable configured computer-readable storage medium
116 instructions executable with processor; may be on removable storage media or in other memory (volatile or non-volatile or both)
118 data
120 kernel(s), e.g., operating system(s), BIOS, UEFI, device drivers
122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, and so on
124 applications, e.g., word processors, web browsers, spreadsheets, games, email tools, commands
126 display screens, also referred to as “displays”
128 computing hardware not otherwise associated with a reference number 106, 108, 110, 112, 114
202 trust boundary, e.g., a boundary around digital assets or around a computing system which stores or provides access to digital data or computing hardware or another digital asset; a trust boundary may be implemented, e.g., as cybersecurity controls which prevent access to a digital asset unless a would-be accessor demonstrates possession of proper authentication and authorization credentials
204 program executable; unless otherwise indicated, an executable includes binary code, such as native code or binary code that runs as managed code
206 target program, namely, a program which apparently has a defect 212 and therefore is a target of diagnosis 302 efforts; a target program may also be referred to simply as a “program” when context indicates that the program is subject to a defect diagnosis effort
208 source code from which an executable 204 was compiled or otherwise generated; not to be confused with decompiled code 404 which is generated from an executable
210 lack of source code 208, i.e., absence or unavailability or illegibility or uncertainty of source code 208; the lack may be due to absence of the source code 208 from a system of interest, due to presence only of encrypted source code 208 for which a decryption key is absent, due to presence only of compressed or scrambled or obfuscated or encoded source code 208 when decompression or descrambling or deobfuscated or decoded source code is absent or unavailable, or due to the presence only of source code that may have been corrupted or tampered with, for example
212 a functionality defect in target program software or in a system running such software; defects may manifest as an erroneous or undesired course of computation, as insufficient or incorrect results, as undesired termination, as deadlocking, as an infinite loop, as inefficient use of processor cycles or memory space or network bandwidth or other computational resources, as undesirable complexity or vagueness in a user interface, as a security vulnerability, or as any other evident deficiency or shortcoming or error
300 aspect of software diagnosis
302 software defect diagnosis; may also be referred to as “software diagnosis” or simply as “diagnosis”; includes, e.g., efforts to identify root causes of defects 212; numeral 302 also refers to an act of diagnosing software, e.g., by performing operations according to one or more of FIGS. 7, 8, and 9
304 diagnostic artifact, e.g., an execution snapshot, an execution dump, a time travel debugging trace, a performance trace, or a heap representation
306 an execution snapshot, e.g., an in-memory copy of a process that shares memory allocation pages with the original process via copy-on-write
308 diagnostic context, e.g., call stacks, exception information, module state information, thread state information, or task state information
310 debug trace, e.g., execution states captured in a time travel trace that can be replayed in forward or in reverse, or execution states captured in a non-time-travel trace; suitable tracing technology to produce a trace 310 may include, for instance, Event Tracing for Windows (ETW) tracing (a.k.a. “Time Travel Tracing” or known as part of “Time Travel Debugging”) on systems running Microsoft Windows® environments (mark of Microsoft Corporation), LTTng® tracing on systems running a Linux® environment (marks of Efficios Inc. and Linus Torvalds, respectively), DTrace® tracing for UNIX®-like environments (marks of Oracle America, Inc. and X/Open Company Ltd. Corp., respectively), and other tracing technologies
312 performance trace, e.g., a trace with execution states that relate specifically to program performance such as memory usage, I/O calls, cycles in a given thread state (running, suspended, etc.), execution time, and so on
314 dump, e.g., a copy of memory contents or other data at a particular point in time; may include a serialized copy of a process; a dump is often stored in one or more files
316 heap, e.g., an area of memory from which objects or other data structures are allocated during program execution
318 heap representation, e.g., a graph or other data structure representing a garbage collection heap or representing a program's usage of a managed heap
320 debugger
322 debugger with functionality to use time-travel traces
324 profiler, e.g., a program that obtains samples of resource usage data during program execution
326 callstack; may also be referred to as “call stack”
328 info about a callstack, e.g., a snapshot of a call stack or statistics about call stacks
330 thread
332 info about a thread, e.g., a snapshot of a thread or statistics about threads
334 heap inspector tool, e.g., software which converts raw data about a heap into graphical or statistical information; a heap inspector may inspect a heap 316 for memory leaks, e.g., patterns such as event handler leaks
336 execution exception, e.g., attempt to divide by zero, attempt to access data or code at an invalid address, developer-defined exceptions, and other interruptions in normal execution flow of a program
338 info about an exception, e.g., a snapshot of execution state associated with an exception, or statistics about exceptions
340 task, e.g., a collection of threads
342 info about a task, e.g., a snapshot of a task or statistics about tasks
344 module, e.g., a collection of objects or a library
346 info about a module, e.g., a snapshot of state associated with a module, or statistics about modules
400 example defect diagnosis system
402 defect diagnosis enhancement software
404 decompiled source code; not to be confused with the source code 208 that was originally compiled to create an executable 204 of interest
406 suspected or actual cause of a defect 212, e.g., thread pool starvation, null reference, memory leak; 406 may refer to a root cause or to a result of the root cause which created additional unwanted program behavior
408 result of source-based software analysis, e.g., output from a source-based software analysis service
410 decompiler interface; may be an intake interface, an output interface, or 410 may refer to both interfaces
412 diagnostic context extractor interface; may be an intake interface, an output interface, or 412 may refer to both interfaces
414 diagnostic context extractor, e.g., a debugger, a time travel trace debugger, a performance profiler, or heap inspector
416 source-based software analysis service interface; may be an intake interface, an output interface, or 416 may refer to both interfaces
418 source-based software analysis service, e.g., a static analysis tool, a statistical analysis tool, a machine learning model trained using source codes, or a neural network trained using source codes; some examples in a given embodiment may also include Microsoft .NET Compiler Platform so-called “Roslyn” analyzers, and Microsoft Program Synthesis using Examples (PROSE) tools
420 developer interface
422 debugging lead
424 focused navigation, e.g., navigation which is constrained in a specified way
426 integrated development environment
428 integrated development environment extension; may also be called a “plug-in”, “plugin”, “add-in”, “addin”, “add-on”, or “addon”
430 web component, e.g., a separately compilable portion of a public-facing website
432 program component, e.g., a separately compilable module, file, library, or other portion of a target program
434 decompiler; reference numeral 434 may also refer to decompiling, namely, an act of performing decompilation
436 service generally; a service may be, e.g., a consumable program offering, in a cloud computing environment or other network or computing system environment, which provides resources to multiple programs or provides resource access to multiple programs, or does both; for present purposes tools 122 are considered to be examples of services
502 static analysis tool, e.g., a tool which analyzes source code without the benefit of dynamic information such as whether an exception occurred or what a call stack snapshot contains; such tools are adapted for use herein in some embodiments by virtue of guiding static analysis in view of dynamic information
504 static analysis of source code, e.g., analysis based on source code alone
506 machine learning model, e.g., neural network, decision tree, regression model, support vector machine or other instance-based algorithm implementation, Bayesian model, clustering algorithm implementation, deep learning algorithm implementation, or ensemble thereof; a machine learning model 506 may be trained by supervised learning or unsupervised learning, but is trained at least in part based on source code as training data; the machine learning model may be trained at least in part using data obtained by harvesting source code history and corresponding bug information from various code bases to discover anti-patterns
508 neural network; a particular example of a machine learning model 506
510 antipattern scanner, e.g., a tool that scans source code looking for implementations of one or more particular antipatterns
512 antipattern, e.g., a software programming pattern which is risky or disfavored, such as a sync-over-async pattern, buffer overflow pattern, non-validated input pattern, improper string termination pattern, and many others
514 static application security testing (SAST) tools, e.g., tools which check for security vulnerabilities such as SQL injections, LDAP injections, XXE, cryptography weakness, or XSS
602 thread pool starvation, e.g., the thread pool is empty because all available threads have been allocated, and a request for another thread therefore fails
604 thread pool
606 null reference, e.g., a pointer unexpectedly is null
608 memory leak, e.g., some allocated memory is not freed after it is no longer in use, and as a result a request for memory failed
610 exploited security vulnerability, e.g., failure to validate data, authentication failure, inadvertent exposure of sensitive data, cross-site scripting, unchanged default account settings, insecure deserialization, cross-site request forgery, and so on
612 unbounded cache growth
614 faulty navigation link, e.g., incorrect hyperlink, incorrect linkage of button to button press handler, and so on
700 data flow diagram; 700 also refers to defect diagnosis methods illustrated by or consistent with FIG. 7
702 execution context, e.g., a runtime, an embedded system, or a real-time system; an execution context may also include context such as “web server”, “cloud”, “production”, etc.
704 collection agent, e.g., part of a diagnosis enhancement software 402 that collects diagnostic artifacts 304, e.g., by copying them to a working directory or creating links to them, or both
706 symbol table, e.g., a data structure created by a compiler which associates identifiers with data type information and other information that was included in source code 208 which declared or defined the variables, routines, or other items that are named by the identifiers
800 flowchart; 800 also refers to defect diagnosis methods illustrated by or consistent with the FIG. 8 flowchart
802 indication of a defect 212, e.g., a program crash, a program timeout, an unexpected exception, or a diagnosis assistance request from a developer to a diagnostic system 400
804 obtain artifact, e.g., by locating the artifact in a file system or in a memory
806 extract diagnostic context 308 from an artifact 304, e.g., by invoking extraction functionality such as that used in extractors 414
808 get decompiled source 404, e.g., by invoking a decompiler or by retrieving previously produced decompiled source 404
810 localize decompilation based on diagnostic context, as opposed to decompiling an entire executable
812 submit decompiled source code to an intake interface of a source-based software analysis service
814 receive analysis results from an output interface of a source-based software analysis service
816 cull analysis results to locate descriptions of causes 406, e.g., by parsing or keyword searches
818 identify a cause, e.g., by displaying it, writing it to a file, or sending it to a developer interface 420
820 avoid requiring a developer to provide original source code 208 to a source-based software analysis service
822 suggest a defect mitigation to a developer, e.g., by displaying a description of the mitigation, writing it to a file, or sending it to a developer interface 420
824 defect mitigation, e.g., suggested patch, suggested source code edit, suggested alternate library, suggested change in configuration, suggested throttling, suggested monitoring of data transfer or computational resource, or another mechanism or action which may reduce 918 or eliminate 920 the adverse impact of a defect 212
900 flowchart; 900 also refers to defect diagnosis methods illustrated by or consistent with the FIG. 9 flowchart (which incorporates the steps of FIG. 8 and the steps of FIG. 7)
902 operate (execute) in a manner or location that is separated by a trust boundary from relevant original source code 208
904 reside (e.g., in memory 112) at a location that is separated by a trust boundary from relevant original source code 208
908 web service, e.g., an interface or resource available through HTTP or HTTPS
910 avoid accessing original source code 208 of a component
912 access original source code 208 of a component
914 avoid exposing a service or tool interface to a developer, e.g., by hiding the data transfers to or from the interface
916 expose a service or tool interface to a developer, e.g., by displaying to a developer the interface itself or the data transfers to or from the interface
918 reduce adverse impact of a defect 212, e.g., reduce the amount of memory leaked, increase the computation required to exploit a security vulnerability, reduce the frequency of an unwanted exception, and so on
920 eliminate an adverse impact of a defect 212, as opposed to merely reducing 918 such impact
922 be disjoint from a debugger; operate without being launched by a debugger and without relying on debugger execution (debugger execution may be permitted, but is not required)
924 be disjoint from a virus scanner; operate without being launched by a virus scanner and without relying on virus scanner execution (virus scanner execution may be permitted, but is not required)
926 virus scanner; may also be referred to as an “antivirus scanner”, “antivirus tool”, or “antivirus service”, or “virus detector”
928 train a machine learning model, e.g., perform familiar training techniques for a given kind of machine learning model, e.g., obtain data, prepare data, feed data to model, and test model for accuracy
930 implement a defect in source code, e.g., synchronously invoke a component which has an asynchronous implementation, fail to check data's size before writing the data to a buffer, and so on
932 display decompiled source to a developer, e.g., in an interface 420
934 avoid displaying decompiled source to a developer
936 transfer data to an intake interface or from an output interface
938 transfer data, or enable data transfer, at least in part by piping data from one tool or other service to another tool or other service
940 transfer data, or enable data transfer, at least in part by invoking one tool or other service in a script and then invoking another tool or other service in the script
942 transfer data containing symbols 706
944 provide diagnostic assistance to a developer
946 use dynamic information 308 to guide a source-based static analysis
948 prioritize possible causes or analysis actions
950 any step discussed in the present disclosure that has not been assigned some other reference numeral

### CONCLUSION

In short, the teachings herein provide a variety of computing system 102 defect 212 diagnosis 302 functionalities which enhance the identification of causes 406 underlying unwanted problems or deficiencies in software 206. Static analysis 504 services and other source-based diagnostic tools 418 and techniques 418 are applied even when the source code 208 underlying the target software 206 is unavailable, e.g., due to its location being unknown or due to an intervening trust boundary 202. Diagnosis 302 obtains 804 diagnostic artifacts 304, extracts 806 diagnostic context 308 from the artifacts, decompiles 434 at least part of the target program 206 to get source 404, and submits 812 decompiled source 404 to a source-based software analysis service 418. The analysis service 418 may be a static analysis tool 502, a SAST tool 514, an antipattern scanner 510, or a neural network 508 or other machine learning model 506 trained on source code, for example. The diagnostic context 308 may also guide 946 the analysis, e.g., by localizing 810 decompilation or prioritizing 948 possible causes. Likely causes 406 are culled 816 from analysis results 408 and identified 818 to a software developer 104. Changes 824 to mitigate 918 or 920 the defect's impact are suggested 822 in some cases. Thus, the software developer receives debugging leads 422 without providing 820, 910 source code 208 for the defective program 206, and without 914 manually navigating through a decompiler 434 interface 410 and through the analysis service interfaces 416 and the context extractor interfaces 412. Another advantage of some embodiments is that they tell the user 104 not merely that a bug 406 was detected 408 by static analysis 418, but also that the application 206 is actually experiencing issues 212 because of that bug. This enables a developer 104 to diagnose issues 212 that they don't necessarily have the expertise to diagnose otherwise.

Embodiments are understood to also themselves include or benefit from tested and appropriate security controls and privacy controls such as the General Data Protection Regulation (GDPR), e.g., it is understood that appropriate measures should be taken to help prevent misuse of computing systems through the injection or activation of malware into diagnostic software. Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 7 through 9 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, sample fields, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A system for identifying causes of computing functionality defects, the system comprising:
a memory;
a processor in operable communication with the memory, the processor configured to perform computing functionality defect identification steps which include (a) obtaining a diagnostic artifact associated with a computing functionality defect of a program, (b) extracting a diagnostic context from the diagnostic artifact, (c) transparently decompiling at least a portion of the program, thereby getting a decompiled source which corresponds to the portion of the program, (d) submitting at least a portion of the decompiled source and at least a portion of the diagnostic context to a source-based software analysis service, (e) receiving from the source-based software analysis service an analysis result which indicates a suspected cause of the computing functionality defect, and (f) identifying the suspected cause to a software developer;
whereby the system provides the software developer with a debugging lead without requiring the software developer to navigate through the diagnostic context.

2. The system of claim 1, wherein the system resides and operates on one side of a trust boundary, and wherein no source code of the program other than decompiled source resides on the same side of the trust boundary as the system.

3. The system of claim 1, wherein the memory contains and is configured by the diagnostic artifact, and the diagnostic artifact includes at least one of the following: an execution snapshot, an execution dump, a time travel debugging trace, a performance trace, or a heap representation.

4. The system of claim 1, wherein the memory contains and is configured by the analysis result, and the analysis result indicates at least one of the following is a suspected cause of the computing functionality defect: a thread pool starvation, a null reference, an unbounded cache, or a memory leak.

5. The system of claim 1, wherein the system comprises at least one of the following diagnostic context extractors: a debugger, a time travel trace debugger, a performance profiler, or a heap inspector.

6. The system of claim 1, wherein the memory contains and is configured by the diagnostic context, and the diagnostic context includes at least one of the following: call stacks, exception information, module state information, thread state information, or task state information.

7. The system of claim 1, wherein the system further comprises the source-based software analysis service, and the source-based software analysis service includes or accesses at least one of the following: a static analysis tool, or a machine learning model.

8. A method for identifying causes of computing functionality defects, the method comprising automatically:
obtaining a diagnostic artifact associated with a computing functionality defect of a program;
extracting a diagnostic context from the diagnostic artifact;
getting a decompiled source which corresponds to at least a portion of the program;
submitting at least a portion of the decompiled source to a source-based software analysis service;
in response to the submitting, receiving from the source-based software analysis service an analysis result which indicates a suspected cause of the computing functionality defect, and
identifying the suspected cause to a software developer;
whereby the method automatically provides the software developer with a debugging lead without requiring the software developer to provide source code for the program.

9. The method of claim 8, wherein the method avoids exposing any of the following to the software developer during an assistance period which begins with the obtaining and ends with the identifying: any diagnostic context extractor user interface, any decompiler user interface, and any intake interface of the source-based software analysis service.

10. The method of claim 8, further comprising suggesting to the software developer a mitigation for reducing or eliminating the computing functionality defect.

11. The method of claim 8, wherein the program includes an executable component which upon execution supports a web service, the computing functionality defect is associated with the executable component, the executable component is a compilation result of a component source, and the method is performed without accessing the component source.

12. The method of claim 8, wherein submitting comprises submitting at least a portion of the decompiled source to at least one of the following: a machine learning model trained using source codes, or a neural network trained using source codes.

13. The method of claim 8, wherein submitting comprises submitting at least a portion of the decompiled source to a machine learning model trained using multiple source code implementations of the computing functionality defect, and wherein the decompiled source also implements the computing functionality defect.

14. The method of claim 8, wherein decompiling is disjoint from any debugger and is also disjoint from any virus scanner, and wherein an operation X is disjoint from a tool Y when X is not launched by Y and when execution of Y is not reliant upon performance of X.

15. The method of claim 8, wherein the method comprises transferring at least a portion of the diagnostic context from a diagnostic context extractor to a decompiler, and also comprises transferring at least a portion of the decompiled source from the decompiler to the source-based software analysis service, and wherein the transferring is performed using at least one of the following: piping, or scripting.

16. A computer-readable storage medium configured with data and instructions which upon execution by a processor cause a computing system to perform a method for identifying causes of computing functionality defects in a program, the method comprising:
transparently getting a decompiled source which corresponds to at least a portion of the program;
submitting at least a portion of the decompiled source to a source-based software analysis service, together with at least a portion of the diagnostic context or a conclusion based on the diagnostic context;
in response to the submitting, receiving from the source-based software analysis service or from another analysis service or from both at least one analysis result which indicates a suspected cause of a computing functionality defect in the program; and
identifying the suspected cause to a software developer;
thereby automatically providing the software developer with a debugging lead without requiring the software developer to provide source code for the program, and without requiring the software developer to navigate through a diagnostic context of the program.

17. The storage medium of claim 16, wherein transparently getting a decompiled source includes transparently feeding a decompiler symbol information of the program.

18. The storage medium of claim 16, wherein the method comprises submitting at least a portion of the decompiled source to each of a plurality of source-based software analysis services, receiving a respective analysis result from each of at least two source-based software analysis services, and identifying multiple suspected causes to the software developer.

19. The storage medium of claim 16, wherein identifying the suspected cause to the software developer includes displaying decompiled source to the software developer.

20. The storage medium of claim 16, wherein the method avoids displaying decompiled source to the software developer.
